(19) United States
(12) Patent Application Publication
(10) Pub. No.: US 2013/0042528 A1
(43) Pub. Date: Feb. 21, 2013

(54) Tree surround decorative planter pot

(71) Applicant: Bobby B. Nason, Jacksonville, FL (US)

(72) Inventor: Bobby B. Nason, Jacksonville, FL (US)

(21) Appl. No.: 13/199,033

(22) Filed: Aug. 18, 2011

(51) Int. Cl. A01G 9/02

(52) U.S. Cl. 47/65.7; 47/85

(57) ABSTRACT

A tree surround planter pot with a pair of identical planter pot halves, a plurality of male and female locking members and a pair of false floor panels. The identical planter pot halves attach to each other at their vertical perimeter edges by the locking members. The resulting planter pot surround has a large aperture in its base to allow a tree that is planted in the ground to appear as if it is growing from within the confines of the pot. The false floor panels rest on internal ledges near the top of the pot so that decorative rocks or soil and flowers can be placed near the top portion of the pot.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of decorative landscape devices and more specifically to tree surround decorative planter pot.

Planter pots for planting flowers and small trees are well known. They can be made out of molded clay, plastic, metal or wood. Traditionally the pot is filled with a growing medium such as soil and a plant or small tree is potted in the soil and its roots remain within the pot.

One pot design that has been disclosed as U.S. Pat. No. 7,428,798 shows a planter surround that is made in two halves that provides a decorative surround for a more traditional, plain planter pot, where the two halves of the decorative surround are joined together at their vertical edges to create the appearance of a complete decorative planter pot.

However, there is a deficiency in the prior technology in that the prior art does not allow for a person to use a decorative planter surround with an already existing tree that is growing in the ground. There is some prior art, such as that seen in U.S. Pat. No. 5,819,468 that discloses a trunk protector that has a tube split in half vertically and secured by stakes, however the purpose of the invention shown in this patent is not meant to be a decorative planter pot tree surround and does not have the necessary false floor to allow decorative rocks or flowers to be planted within the surrounding tube.

### BRIEF SUMMARY OF THE INVENTION

The primary object of the invention is to provide a tree surround in the shape of a flower pot that makes it appear that the tree, which is growing in the ground, is planted in the pot. The pot includes a large aperture at the bottom which allows a tree, which is planted in the ground, to appear as if it planted within the pot.

Another object of the invention is to provide a tree surround in the shape of a flower pot that is constructed of two identical halves.

Another object of the invention is to provide a tree surround in the shape of a flower pot that includes a false bottom panel to support decorative rocks.

Yet another object of the invention is to provide a tree surround in the shape of a flower pot that includes air vents in the side walls for allowing air to access the soil located in the flower planter.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a tree surround decorative planter pot comprising: a pair of identical planter pot halves, a plurality of male and female locking members and a pair of identical false floor panels, said identical planter pot halves each capable of being attached to each other at their vertical perimeter edges by said locking members, the resulting said planter pot surround member having a large aperture at the base of said pot for allowing a tree that is planted in the ground to appear as if said tree is growing from within said planter pot, said false floor panels capable of resting on an internal ledge formed within said planter surround walls so that decorative rocks or potted flowers can be placed on the said false floor panel near the top portion of said planter pot.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the invention.

FIG. 2 is an exploded view of the invention.

FIG. 3 is a top plan view of the invention.

FIG. 4 is a side section view of the invention showing decorative rocks placed on the false bottom insert panels.

FIG. 5 is a side section view of the invention showing soil and flowers placed on the false bottom insert panels

FIG. 6 is a perspective view of the underside of the false bottom insert panels

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

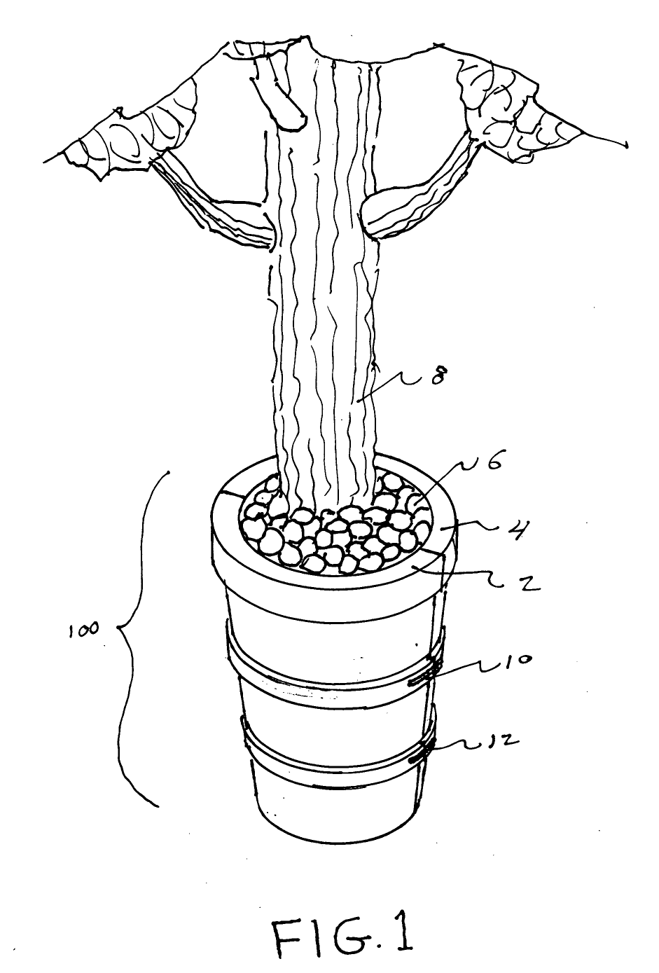

Referring now to FIG. 1 we see a perspective view of the decorative planter surround 100 of the present invention. The planter surround is made of two identical halves 2, 4. Because they are identical, there is a saving in tooling costs. Vents 10, 12 help introduce air into the inside of the planter as will be explained in more detail below. Rocks 6 or other decorative elements can be installed into the planter to surround the tree trunk 8 that is exiting from the center of the planter 100.

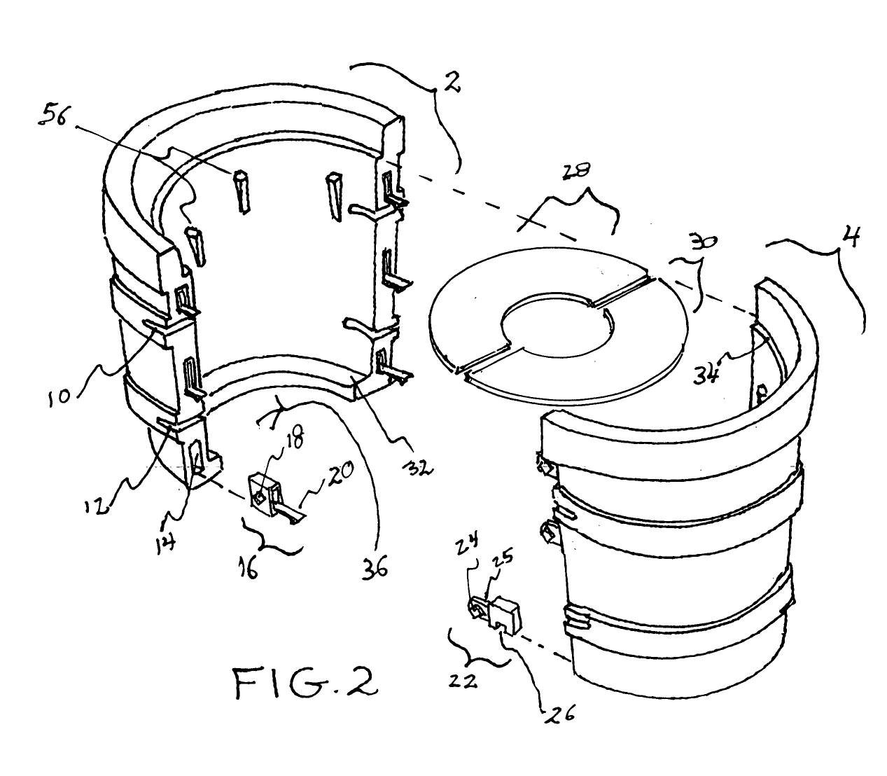

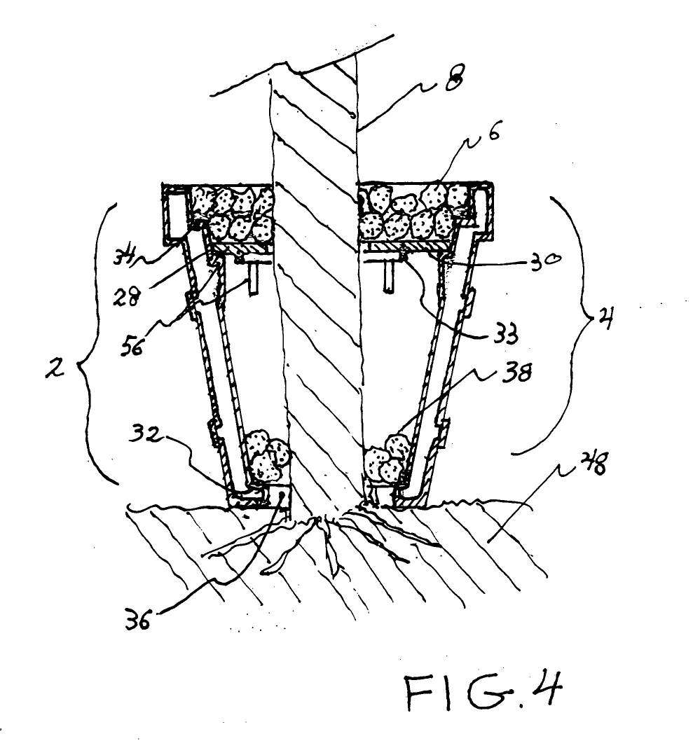

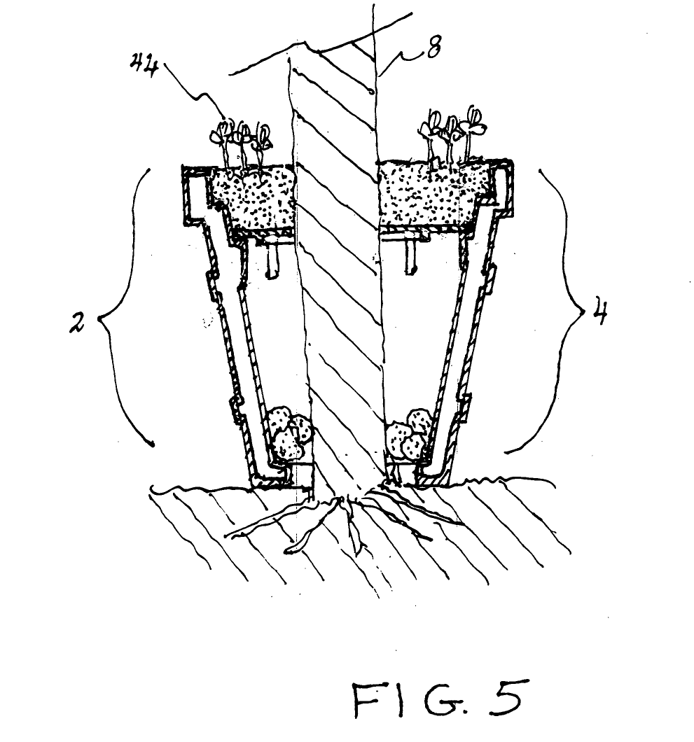

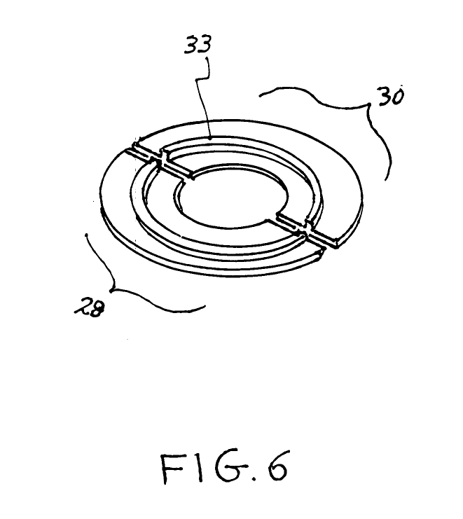

FIG. 2 shows an exploded view of the invention. The two halves 2, 4 of the decorative planter surround are held together by a plurality of locking members 16, 22. The locking members 16, 22 are inserted into sockets 14. This method is duplicated for all locking members. Locking member 16 includes a cutout area 18 and a resilient tab 20. Locking member 22 includes a protrusion 24 mounted on a resilient tab 25. Locking member 22 also includes a cutout portion 26. When the two locking members 16, 22 are pushed together, protrusion member 24 pops into cut out portion 18 and tab portion 20 snaps into cutout portion 26 thereby keeping the two planter halves 2, 4 fixedly attached to each other. Of course other connecting means can be envisioned such as a post and hole door hinge type connection or extruded vertical U shaped channel members that could mate with corresponding channels mounted on the side walls of the planter pot halves. The bottom of the planter 2, 4 includes a large aperture 36 that allows the trunk of a tree 8, or other large plant to extend from the ground in which it is planted, through the planter 100 making it appear that the tree 8 is planted inside the decorative planter surround 100. Ledge members 56 allow a false bottom made of half plates 28, 30 to rest on the ledges 56 so that rocks 6 appear that they are filling the planter whereas they are really filling only the top most portion of the planter 100. The rock supporting plates 28, 30 include a rib 33 on the underside of the panels 28, 30 as shown in the perspective view in FIG. 6 so that the user can enlarge the plate portions 28, 30 by cutting the plate portions of the plate 28, 30 at the location of the rib 33 using it as a cutting guide allowing tree trunks of larger diameter to be accommodated. Bottom ledge 32 allows the user to place rocks 38 or other heavy stabilizing members as shown in the section view in FIG. 4. In the embodiment shown, the planter halves 2, 4 are made of rotationally molded plastic such as cross linked polyethylene. This type of construction creates a strong and durable unit and the double wall gives room for inserting the locking members 16, 22. The slots 10, 12 are molded into the planter halves 2, 4 and create air passages that enable fresh air to enter the inside of the planter thereby helping to provide fresh air to the tree trunk 8 and upper root system as well as for plants that may be growing in trays 40, 42 around the tree trunk 8 as shown in FIG. 5.

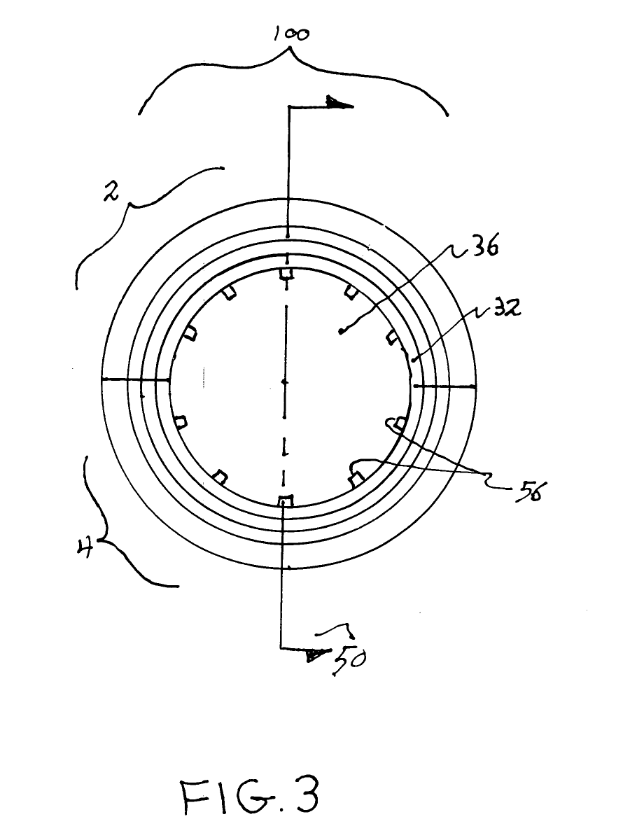

FIG. 3 shows a top plan view of the planter 100 of the present invention. The two halves 2, 4 are joined together. Ledge members 56 can be clearly seen as well as lower aperture 36.

FIG. 4 shows a section view that bisects the invention 100 as defined by section line 50 shown in FIG. 3. Tree 8 can be seen planted into the ground 48 and protruding through aperture 36 and continuing up and out of the planter pot 2, 4. Rocks 38 can be clearly seen as helping to hold down the planter 100. False bottom 28, 30 can be clearly seen in place and supporting decorative rocks 6. The double wall construction of the rotationally molded planter halves can be clearly seen. Of course, other construction methods can be employed. For example, the two halves 2, 4 can be injection molded from rigid plastic and have molded in internal ribs that can retain the locking members 16, 22. Alternately, the halves 2, 4 can be stamped or welded from sheet metal. Or the planter halves 2, 4 can be made from wood or molded crushed stone and resin binder.

FIG. 5 shows a similar section view as section 4, however flowers are planted in soil that is supported by the false bottom plates 28, 30. This configuration allows for the appearance of a fully filled soil planter, when in reality only the top most portion of the planter is filled with soil.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

1-5. (canceled)

6. A tree surround decorative planter pot comprising:
a pair of planter pot halves;
each of said decorative planter pot halves defined by inner and outer planter pot surfaces laterally bordered by generally vertical perimeter edges and configured to be joined together at said edges to form a unitary decorative planter pot;
cooperative locking members for attaching said pot halves to one another at said edges;
said unitary decorative planter pot further comprising an upper and lower end, each of which is configured to define a generally central opening extending through said decorative planter pot from said lower to said upper end;
at least one ledge located within said planter pot and extending inwardly from said inner planter pot surface and spaced from said planter pot upper end;
a pair of false floor panel sections defined by generally arcuate outer surfaces supportably engaged upon said at least one inwardly extended ledge, said false floor panel sections configured with opposed arcuate inner surfaces cooperating to define a false floor opening generally axially aligned with said generally central opening;
whereby said decorative planter pot may be assembled about a tree planted in the ground with a trunk of said tree passing through said central and false floor openings so as to appear as if said tree is growing from within said decorative planter pot, and said false floor panel sections support decorative plantings within said decorative planter pot.

7. A tree surround decorative planter pot as set forth in claim 6 wherein said decorative planter pot halves are fabricated from molded rigid plastic and include internally molded ribs to fixedly retain said locking elements.

8. A tree surround decorative planter pot as set forth in claim 6 wherein said decorative planter pot halves include a plurality of air vents to allow air to enter said planter pot.

9. A tree surround decorative planter pot as set forth in claim 6 wherein said planter pots halves are fabricated of molded clay.

10. A tree surround decorative planter pot as set forth in claim 6 wherein said planter pot halves are constructed of stamped metal.

11. A tree surround decorative planter pot wherein said pot includes:
at least two pot segments including inner and outer segment surfaces configured to be joined together at surface perimeter edges to form a unitary decorative planter pot;
locking members disposed at said perimeter edges to attached said pot segments together;
said inner segment surfaces of said pot segments cooperate to define a generally central opening within said unitary decorative pot, said opening extending from a bottom surface of said decorative pot to a top surface of said decorative pot, each said pot segment inner surface including at least one inwardly extending support ledge spaced below said decorative pot top surface;
false floor panel sections defined by generally arcuate outer edges configured to be supportably engaged on said at least one support ledge, said false floor panel sections further including arcuate inner edges and cooperating to define a false floor opening spaced below said decorative pot top surface and generally axially aligned with said generally central;
whereby said decorative planter pot, when secured together by said locking members about a trunk of a tree planted in the ground, said tree trunk will appear to be growing from within said decorative planter pot, while said false floor is utilized for supporting additional decorative plantings.
